(19) United States
(12) Patent Application Publication
(10) Pub. No.: US 2003/0065772 A1
(43) Pub. Date: Apr. 3, 2003

(54) MPLS packet statistical process method and statistical process apparatus

(75) Inventor: Gento Hata, Tokyo (JP)

Correspondence Address: FISH & RICHARDSON P.C., 45 ROCKEFELLER PLAZA, SUITE 2800, NEW YORK, NY, 10111, US

(73) Assignee: Ando Electric Co., Ltd., Tokyo (JP)

(21) Appl. No.: 10/260,160

(22) Filed: Sep. 27, 2002

(30) Foreign Application Priority Data
Sep. 28, 2001 (JP) P. 2001-298718

(51) Int. Cl. G06F 17/40

(52) U.S. Cl. 709/224

(57) ABSTRACT

An MPLS packet statistical process apparatus includes a label extracting portion for extracting a transfer label and a VPN identification label from a PPP frame in an input MPLS-VPN packet, a counting portion for counting the number of packets and the number of octets every combination of the transfer label and the VPN identification label, which are extracted, and a matrix forming portion for forming a matrix of each combination of the transfer label and the VPN identification label based on the number of packets and the number of octets, which are counted.

### BACKGROUND OF THE INVENTION

1. Field of the Invention

The present invention relates to a packet statistical process method in the VPN (Virtual Private Network) network using the MPLS (Multiprotocol Label Switching) technology.

2. Description of the Related Art

Hitherto, in IP (Internet Protocol), there is MPLS as a routing technology that transfers data at a high speed. An example of a packet format and a SIM header (header of MPLS) when MPLS is applied is shown in FIG. 1.

In FIG. 1, a transfer label is added between the PPP (Point-to-Point Protocol) header in the data link layer and the IP header in the network layer. The transfer label is referred to as the SIM header.

In the MPLS, switching is executed using the transfer label.

Accordingly, the higher-speed packet transfer can be achieved rather than the transfer based on the routing table in the network layer.

The SIM header includes a label (20 bit), an EXP (3 bit), an S (1 bit), and a TTL (8 bit).

A plurality of SIM headers can be inserted between the PPP header and the IP header (label stack). The SIM header including the S of 1 indicates that the SIM header is the last one in the label stack.

An example of the packet transmission using the transfer label (label) will be explained with reference to FIG. 2 hereunder.

A label “3” indicating that this packet is addressed to A is added to a packet for A by a first MPLS edge router (R1).

The label “3” is looked up by the next MPLS core router (R2) (one core router (R2) is shown in FIG. 2, but the packet may be transferred through a plurality of core routers), and then the packet is transferred to the concerned interface.

The label is removed by the last MPLS edge router (R3) prior to A, and then the packet reaches A.

An example of the packet format when the VPN network is constructed using the MPLS (referred to as the “MPLS-VPN packet” hereinafter) is shown in FIG. 3.

The VPN network is constructed by the MPLS-VPN packet in which the transfer label in FIG. 1 is added and a VPN identification label is added after the transfer label.

An example of the packet transfer of a VPN-A user constructed by a MPLS-VPN applicable router is shown in FIG. 4.

The VPN identification label and the transfer label are added to the packet, which is transmitted from the VPN-A user, by the first MPLS edge router 1. At this time, the outside label is the transfer label and the inside label is the VPN identification label.

Only the transfer label on the outside is looked up in the MPLS core router 2, and then the packet is transmitted to the concerned interface.

The VPN identification label on the inside is looked up in the last MPLS edge router 3, and then it is decided that concerned VPN is the VPN-A user. Then, the packet is transferred to the packet after the label is removed.

In the MPLS-VPN packet transfer network according to the related art, when a traffic amount is measured between the MPLS edge router and the MPLS core router in FIG. 4 using the traffic monitoring system, it is impossible to take statistics of the traffic amount of each user and traffic amounts of the user in respective areas, i.e., which areas (which edge routers) such traffics are directed to by the user in combination.

### SUMMARY OF THE INVENTION

It is an object of the present invention to provide an MPLS packet statistical process method (apparatus) capable of taking statistics of a traffic amount of a user in the MPLS-VPN packet transfer network and traffic amounts of the user in each area in combination.

In order to overcome the problems, there is provided an MPLS packet statistical process method including the steps of extracting a transfer label and a VPN identification label from a PPP frame in an inputted MPLS-VPN packet by an edge router, counting number of packets and number of octets every combination of the transfer label and the VPN identification label, and forming a matrix of each combination of the transfer label and the VPN identification label based on the number of packets and the number of octets, which are counted.

Also, when a plurality of desired labels are inserted between the transfer label and the VPN identification label, the extraction of the VPN identification label is executed based on whether or not S in a SIM header is 1. Therefore, even when a plurality of desired labels are inserted, the extraction of the VPN identification label can be easily carried out.

Also, the method further includes the steps of providing the matrix of each combination of the transfer label and the VPN identification label to an external NMS to take a statistical process of a traffic amount of each combination of the transfer label and the VPN identification label. Therefore, in the external NMS (Network Management System), the exact MPLS packet statistical process can be executed based on the traffic amount, the packet transferring distance, etc. about each user (network).

Also, since the exact analysis can be executed based on the traffic amount, the packet transferring distance, etc. about each user (network) by the statistical process of the traffic amount, it is particularly effective to employ such process in the accounting.

Also, there is provided an MPLS packet statistical process apparatus including a label extracting portion for extracting a transfer label and a VPN identification label from a PPP frame in an inputted MPLS-VPN packet, a counting portion for counting number of packets and number of octets every combination of the transfer label and the VPN identification label, which are extracted, and a matrix forming portion for forming a matrix of each combination of the transfer label and the VPN identification label based on the number of packets and the number of octets, which are counted.

Also, the apparatus further includes a storing portion for storing the matrix of each combination of the transfer label and the VPN identification label. Therefore, a large quantity of data that are subjected to the statistical process can be accumulated and then output at any points of time.

Also, the apparatus further includes a VPN identification label extracting portion for executing an extraction of the VPN identification label when S in a SIM header is 1. Therefore, even when a plurality of any labels are inserted, the apparatus that can extract easily the VPN identification label can be constructed.

### BRIEF DESCRIPTION OF THE DRAWINGS

FIG. 1 is a view showing a relationship between an example of a packet format and a SIM header when MPLS is applied as a routing technology for transmitting data at high speed in IP.

FIG. 2 is a view showing an example of the packet transmission using the transfer label (label).

FIG. 3 is a view showing an example of the packet format when the VPN is constructed by using MPLS.

FIG. 4 is a view showing an example of the packet transfer of the VPN-A user constructed by the MPLS-VPN applicable router.

FIG. 5 is a view showing a concept of a statistical data process in the MPLS-VPN packet traffic monitoring method.

FIG. 6 is a view showing an example in which a plurality of desired labels are stacked between the transfer label and the VPN identification label.

FIG. 7 is a view showing an example of data that are processed statistically as a matrix and expanded in the memory.

### DETAILED DESCRIPTION OF THE PREFERRED EMBODIMENTS

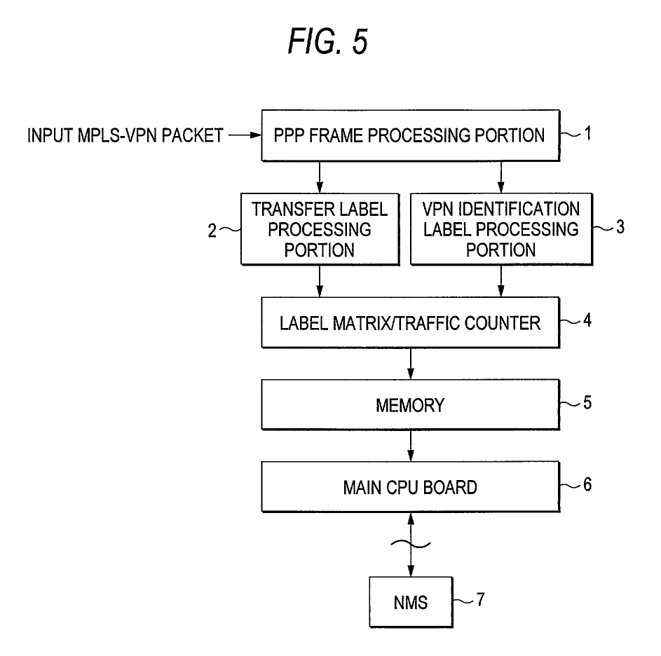

An embodiment of the present invention will be explained in detail with reference to FIG. 5 hereinafter.

FIG. 5 is a view showing a concept of a statistical data process in the MPLS-VPN packet traffic monitoring method.

First, in an edge router, a transfer label and a VPN identification label are extracted from a PPP frame of an input MPLS-VPN packet in a PPP frame processing portion 1.

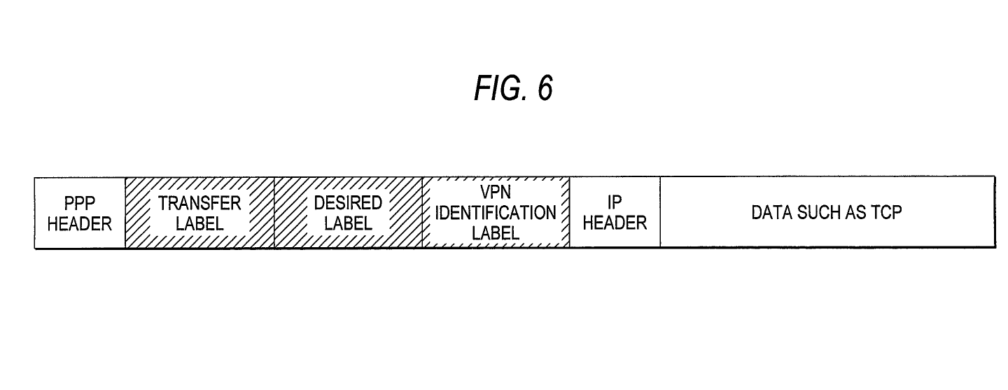

At this time, as shown in FIG. 6, when a plurality of desired labels are stacked between the transfer label and the VPN identification label may be considered.

In the case of FIG. 6, because the transfer label is positioned on the outermost side, only the transfer label can be extracted when the label positioned immediately after the PPP header is extracted by the PPP frame processing portion.

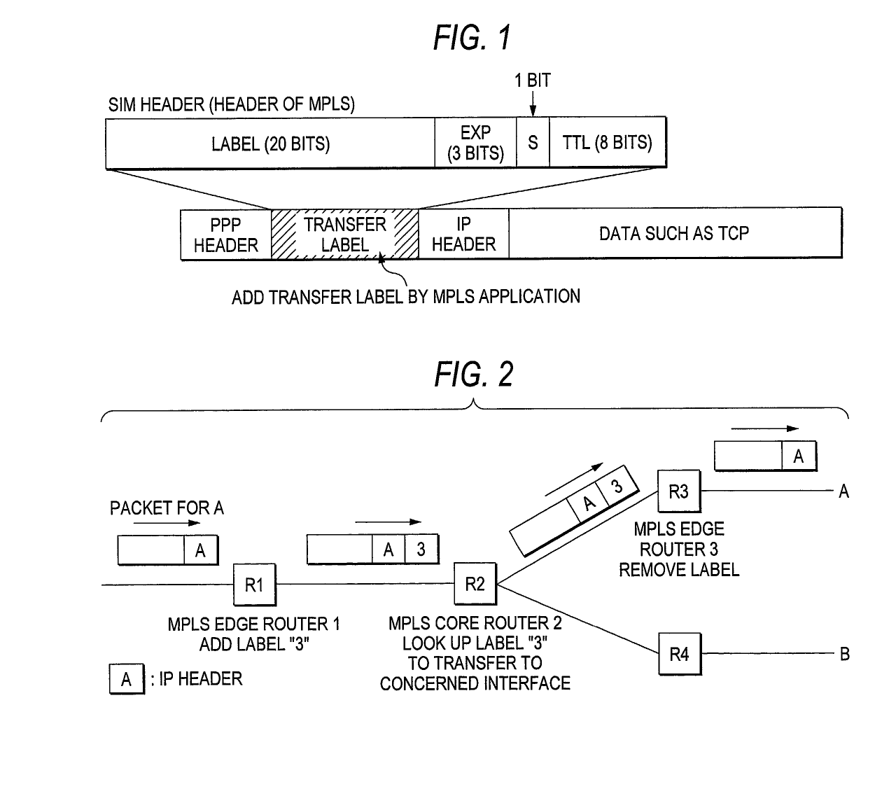

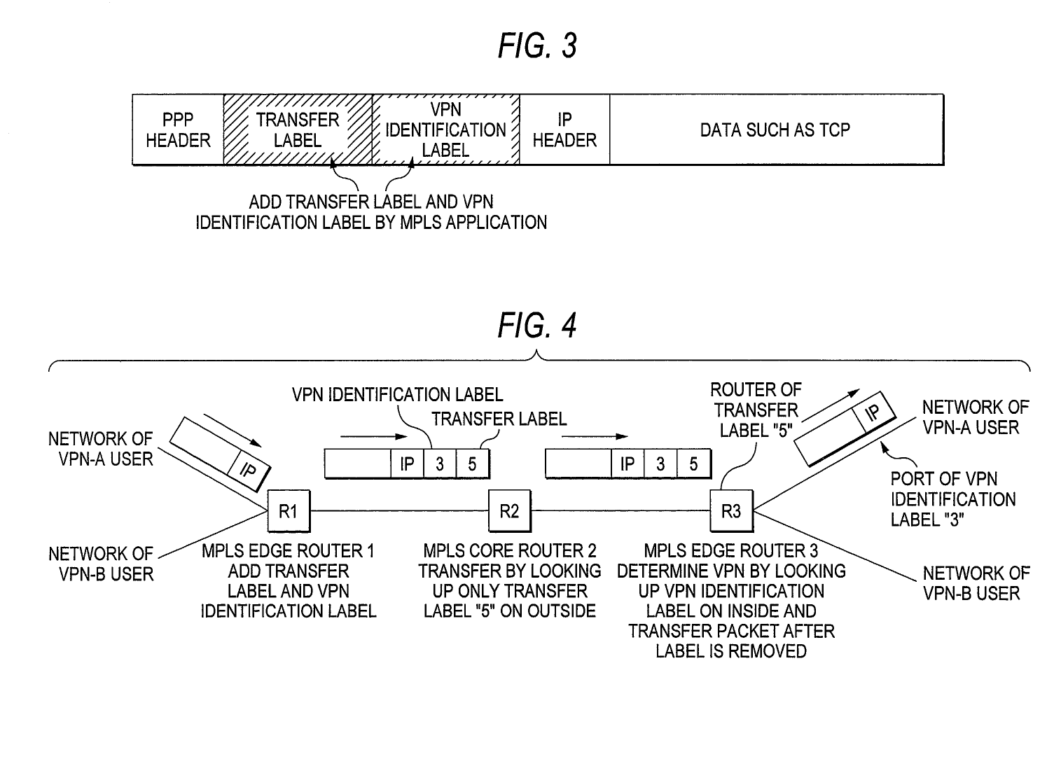

Also, because the VPN identification label is positioned on the innermost side, only the VPN identification label can be extracted when the label having S of 1 in the SIM header shown in FIG. 1 is extracted.

Then, in a transfer label processing portion 2, information of the transfer label are transferred to a label matrix/traffic counter 4.

Also, in a VPN identification label processing portion 3, information of the VPN identification label are transferred to the label matrix/traffic counter 4.

In the label matrix/traffic counter 4, a matrix is generated from the transfer label and the VPN identification label, and number of packets and number of packets/octets are counted every combination.

The matrices are constructed every processed transfer label and processed VPN identification label. The number of packets and the number of octets are counted and stored in a memory 5 as statistical information.

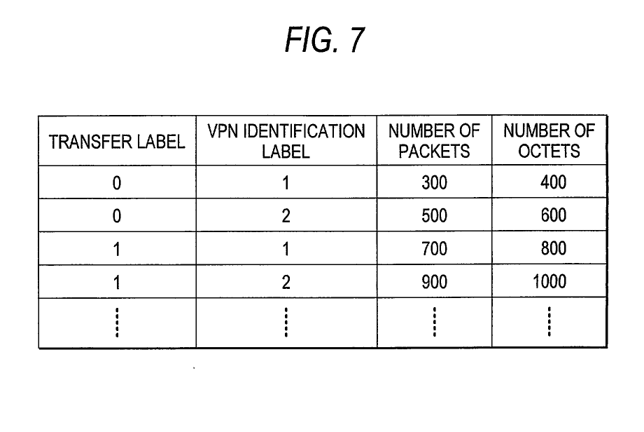

An example of the data that are processed statistically as the matrix and expanded in the memory is shown in FIG. 7.

In FIG. 7, the number of packets and the number of octets are recorded in response to the VPN identification label (destination user network) (1, 2, . . . ) every transfer label (core router) (0, 1, . . . ).

In this case, the data in FIG. 7 are processed statistically with respect to the inputted MPLS-VPN packets and the outputted MPLS-VPN packets every core router.

The statistical information stored in the memory every label can be accessed from a main CPU board 6. Thus, the exact accounting set can be attained based on the traffic amount, the packet transferring distance, etc. for each user (network), for example, by looking up in an external NMS (Network Management System) 7.

According to a first aspect of the invention, there is provided an MPLS packet statistical process method including the steps of extracting a transfer label and a VPN identification label from a PPP frame in an inputted MPLS-VPN packet by an edge router, counting number of packets and number of octets every combination of the transfer label and the VPN identification label, and forming a matrix of each combination of the transfer label and the VPN identification label based on the number of packets and the number of octets, which are counted. Therefore, the traffic amount of the user and traffic amounts of the user in respective areas can be taken as the statistical information in combination by counting the number of packets and the number of octets in combination with respective labels based on the transfer label and the VPN identification label in the MPLS-VPN packet.

According to a second aspect of the invention, when a plurality of desired labels are inserted between the transfer label and the VPN identification label, the extraction of the VPN identification label is executed based on whether or not S in a SIM header is 1. Therefore, even when a plurality of desired labels are inserted, the extraction of the VPN identification label can be easily carried out.

According to a third aspect of the invention, the method further includes the steps of providing the matrix of each combination of the transfer label and the VPN identification label to an external NMS to take a statistical process of a traffic amount of each combination of the transfer label and the VPN identification label. Therefore, in the external NMS (Network Management System), the traffic amount of the user and traffic amounts of the user in respective areas can be collected statistically in combination.

As a result, the exact statistical process can be executed based on the traffic amount, the packet transferring distance, etc. about each user, for example, and thus the effect such that the available field of the traffic monitoring system is expanded can be achieved.

According to a fourth aspect of the invention, since the exact analysis can be executed based on the traffic amount, the packet transferring distance, etc. about each user (network) by the statistical process of the traffic amount, it is particularly effective to employ such process in the accounting.

According to a fifth aspect of the invention, there is provided an MPLS packet statistical process apparatus including a label extracting portion for extracting a transfer label and a VPN identification label from a PPP frame in an inputted MPLS-VPN packet, a counting portion for counting number of packets and number of octets every combination of the transfer label and the VPN identification label, which are extracted, and a matrix forming portion for forming a matrix of each combination of the transfer label and the VPN identification label based on the number of packets and the number of octets, which are counted. Therefore, the traffic amount of the user and traffic amounts of the user in respective areas can be taken as the statistical information in combination by counting the number of packets and the number of octets in combination with respective labels based on the transfer label and the VPN identification label in the MPLS-VPN packet.

According to a sixth aspect of the invention, the apparatus further includes a storing portion for storing the matrix of each combination of the transfer label and the VPN identification label. Therefore, a large quantity of data that are subjected to the statistical process can be accumulated and then output at any points of time.

According to a seventh aspect of the invention, the apparatus further includes a VPN identification label extracting portion for executing an extraction of the VPN identification label when S in a SIM header is 1. Therefore, even when a plurality of desired labels are inserted, the apparatus that can extract easily the VPN identification label can be constructed.

What is claimed is:

1. An MPLS packet statistical process method comprising the steps of:
extracting a transfer label and a VPN identification label from a PPP frame in an inputted MPLS-VPN packet by an edge router;
counting number of packets and number of octets every combination of the transfer label and the VPN identification label; and
forming a matrix of each combination of the transfer label and the VPN identification label based on the number of packets and the number of octets, which are counted.

2. The method according to claim 1, wherein when a plurality of desired labels are inserted between the transfer label and the VPN identification label, the extraction of the VPN identification label is executed based on whether or not S in a SIM header is 1.

3. The method according to claim 1, further comprising the steps of providing the matrix of each combination of the transfer label and the VPN identification label to an external NMS to take a statistical process of a traffic amount of each combination of the transfer label and the VPN identification label.

4. The method according to claim 3, further comprising the steps of employing the statistical process of the traffic amount in accounting.

5. An MPLS packet statistical process apparatus comprising:
a label extracting portion for extracting a transfer label and a VPN identification label from a PPP frame in an inputted MPLS-VPN packet;
a counting portion for counting number of packets and number of octets every combination of the transfer label and the VPN identification label, which are extracted; and
a matrix forming portion for forming a matrix of each combination of the transfer label and the VPN identification label based on the number of packets and the number of octets, which are counted.

6. The apparatus according to claim 5, further comprising:
a storing portion for storing the matrix of each combination of the transfer label and the VPN identification label.

7. The apparatus according to claim 5, further comprising:
a VPN identification label extracting portion for executing an extraction of the VPN identification label when S in a SIM header is 1.
